(19) United States
(12) Patent Application Publication
(10) Pub. No.: US 2015/0375673 A1
(43) Pub. Date: Dec. 31, 2015

(54) SYSTEMS AND METHODS FOR VEHICLE GLASS PANELS WITH INTEGRATED LIGHTING COMPONENTS

(71) Applicant: GM GLOBAL TECHNOLOGY OPERATIONS LLC, Detroit, MI (US)

(72) Inventors: ROQUE A. TESTAI, SAO PAULO (BR); PAULO A. RIEDEL, SAO PAULO (BR)

(21) Appl. No.: 14/314,611

(22) Filed: Jun. 25, 2014

(51) Int. Cl. B60Q 1/26; B60Q 1/20; B60Q 1/38; B60Q 1/46; B60Q 1/44

(52) U.S. Cl. CPC B60Q 1/268; B60Q 1/46; B60Q 1/44; B60Q 1/38; B60Q 1/2696; B60Q 1/20; B60Q 2400/50

(57) ABSTRACT

A lighting assembly for a vehicle includes a glass panel configured to be installed on the vehicle (e.g., a front windshield or rear window), and a substantially planar lighting component (e.g., a plurality of light-emitting diodes (LEDs) integrated into a perimeter margin region of the glass panel. In accordance with various embodiments, the substantially planar lighting component is configured as a turn signal, a brake indicator, or a warning light.

### TECHNICAL FIELD

The technical field generally relates to automotive vehicles, and more particularly relates to the integration of functional lighting components such as turn signal lights, warning lights, brake lights, and the like in such automotive vehicles.

### BACKGROUND

Automotive vehicles traditionally incorporate a wide range of lighting types for use in connection with warning lights, brake lights, turn signals, and the like. Installation of these lighting components can require significant overhead in the form of cabling (e.g., wiring harnesses), fixturing, lenses, and mounting apparatus. These components also increase vehicle body weight, require significant vendor tooling, and require complex body dimension fitting to accommodate particular lighting designs. That is, the use of traditional lighting components places a restriction on the range of body designs. Furthermore, the service cost associated with repairing traditional lighting components increases as the complexity of such components increases.

Accordingly, it is desirable to provide improved vehicle lighting solutions that are light weight, reduce manufacturing complexity and costs, and allow a greater range of vehicle body designs. Additional desirable features and characteristics of the present invention will become apparent from the subsequent detailed description and the appended claims, taken in conjunction with the accompanying drawings and the foregoing technical field and background.

### SUMMARY

In accordance with one embodiment, a lighting assembly for a vehicle includes a glass panel configured to be installed on the vehicle (e.g., a front windshield or rear window), and a substantially planar lighting component (e.g., a plurality of light-emitting diodes (LEDs) integrated into a perimeter margin region of the glass panel. In accordance with various embodiments, the substantially planar lighting component is configured as a turn signal, a brake indicator, or a warning light.

In accordance with another embodiment, a method of fabricating a lighting assembly of a vehicle includes: providing a glass panel configured to be installed on the vehicle, the glass panel having a perimeter margin region; integrating a substantially planar lighting component into the glass panel in the perimeter margin region; and forming an electrically conductive trace coupled to the substantially planar lighting component and extending to an edge of the glass panel.

### DESCRIPTION OF THE DRAWINGS

The exemplary embodiments will hereinafter be described in conjunction with the following drawing figures, wherein like numerals denote like elements, and wherein:

FIGS. 1 and 2 are partial cross-sectional views of lighting components integrated into a glass panel in accordance with various embodiments.

FIG. 3 is a front view of an exemplary vehicle with integrated lighting components in accordance with one embodiment.

FIG. 4 is a rear view of an exemplary vehicle with integrated lighting components in accordance with one embodiment.

FIG. 5 is a rear view of an exemplary vehicle with integrated lighting components in accordance with one embodiment.

FIG. 6 is a rear view of an exemplary vehicle with integrated lighting components in accordance with one embodiment.

FIG. 7 is a rear view of an exemplary vehicle with integrated lighting components in accordance with one embodiment.

FIG. 8 is a front view of an exemplary vehicle with integrated lighting components in accordance with one embodiment.

FIG. 9 is an exemplary interconnect system for integrated lighting components in accordance with one embodiment.

FIG. 10 is close-up of a corner of an exemplary glass panel with integrated lighting in accordance with one embodiment.

FIG. 11 is flowchart depicting a method in accordance with one embodiment.

### DETAILED DESCRIPTION

The subject matter described herein generally relates to vehicle glass panels (such as the windshield, rear window, etc.) with integrated lighting components, such as turn signals, brake indicators, warning lights, and the like. The following detailed description is merely exemplary in nature and is not intended to limit the application and uses. Furthermore, there is no intention to be bound by any expressed or implied theory presented in the preceding technical field, background, brief summary or the following detailed description. As used herein, the term “module” refers to an application specific integrated circuit (ASIC), an electronic circuit, a processor (shared, dedicated, or group) and memory that executes one or more software or firmware programs, a combinational logic circuit, and/or other suitable components that provide the described functionality.

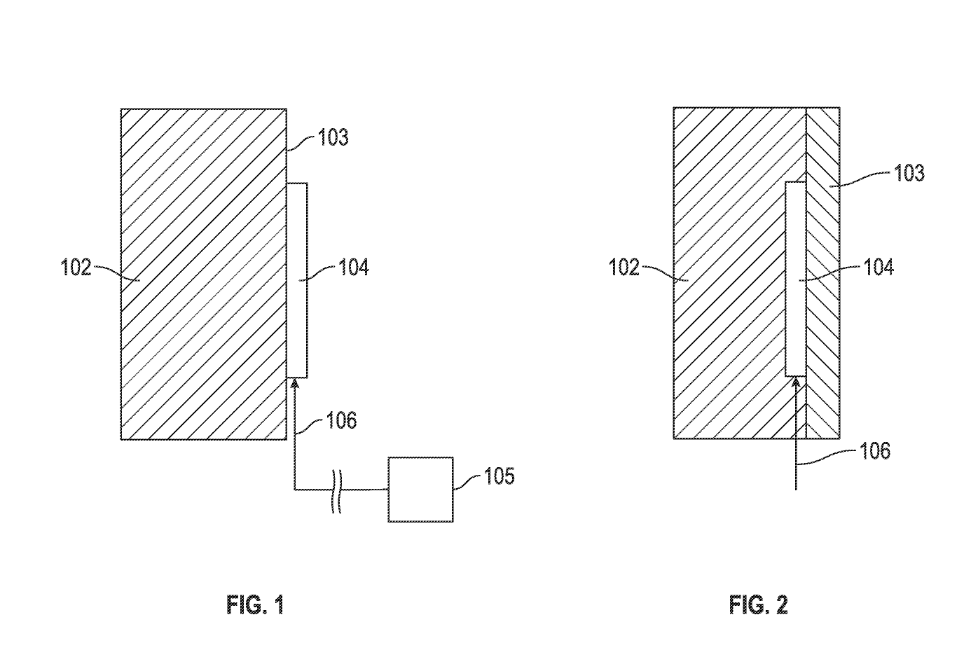

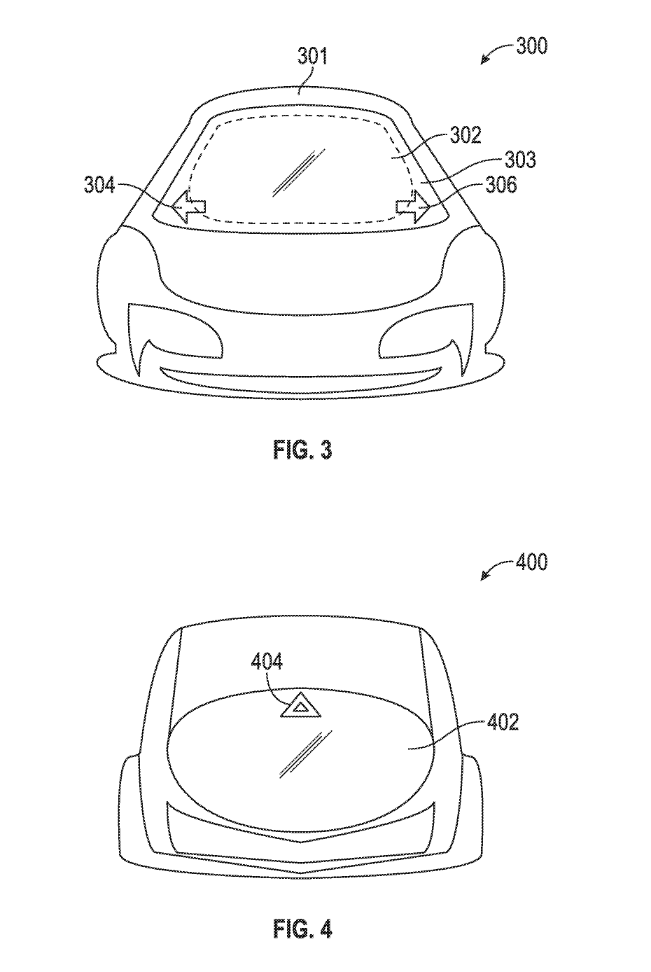

FIGS. 1 and 2 provide partial cross-sectional overviews of lighting components integrated into a glass panel in accordance with exemplary embodiments, and FIGS. 3-8 depict a number of non-limiting examples of automotive vehicles having lighting assemblies integrated into the their front and/or rear windows. Referring first to FIG. 1, a lighting assembly 100 in accordance with one embodiment generally includes a glass panel 102 (comprising any conventional auto glass material known in the art) configured to be installed on a vehicle (e.g., as a front windshield, rear window, or the like), and a substantially planar lighting component (or simply “lighting component”) 104 integrated on or into glass panel 102. In this regard, the term “integrated” as used herein with respect to glass panel 102 means that lighting component 104 is secured to glass panel 102 (e.g., adhesively attached to a surface 103 of glass panel 102), embedded within glass panel 102, or otherwise coupled with glass panel 102 such that the two components can together be handled and installed in a vehicle as a single unitary structure. Surface 103 may correspond to a surface facing either the interior or the exterior of the vehicle.

Lighting component 104 may be implemented as any substantially planar component or set of components configured to produce light—either as a collection of individual light sources or as a contiguous light-producing sheet. Lighting component 104 may, for example, be implemented as one or more light emitting diodes (LEDs), such as a thin sheet of micro-LEDs or standard LEDs, organic light emitting diodes (OLED), liquid crystal displays (LCDs) (with or without backlighting), or the like. In some embodiments, lighting component 104 comprises a thin-film LCD display such as those often used in connection with smart phones and tablet computers. Lighting component 104 is “substantially planar” in one sense in that it is significantly thinner than glass panel 102. In one embodiment, for example, lighting component is between 0.5 and 1.0 mm.

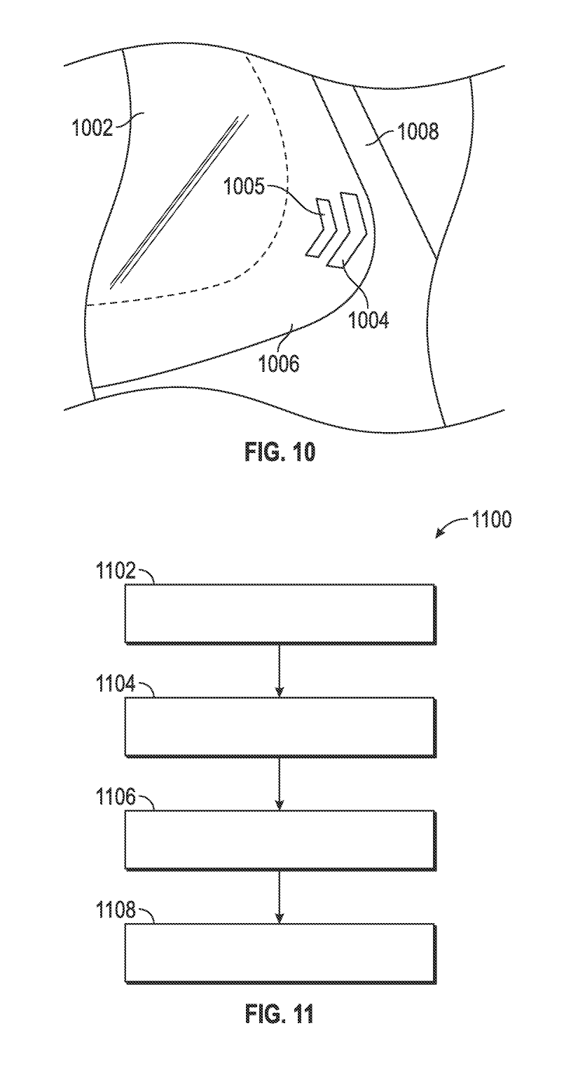

The position of lighting component 104 with respect to glass panel 102 will typically vary depending upon the nature and function of lighting component 104 (e.g., whether it is being used as a brake signal, a turn signal, etc.). However, in many embodiments in which lighting component 104 is not entirely transparent, it is desirable that it be placed in a position outside the primary field of view of the driver and/or passengers of the vehicle. That is, referring briefly to the example shown in FIG. 10, a glass panel 1002 will generally include a perimeter margin region 1007 (e.g., a 0.5 to 3.0 inch band) extending from its outer edge such that it is substantially outside the primary field of view of the driver and/or passenger. In the illustrated embodiment, lighting component 1004 is a turn-signal light formed as a series of chevron segments using a plurality of individual LEDs (e.g., micro-LEDs) 1005 placed at a corner of an A-pillar 1008. Also depicted in FIG. 10 is a serigraphic layer (or other fully or partially opaque region) 1006, which may be used to assist in integrating the lighting component with the glass panel. Referring to the lighting assembly 200 of FIG. 2, for example, light component 104 is shown as disposed between a serigraphic layer 108 and surface 103 of glass panel 102. That is, light component 104 is effectively “laminated” onto glass panel 102 by serigraphic layer 108.

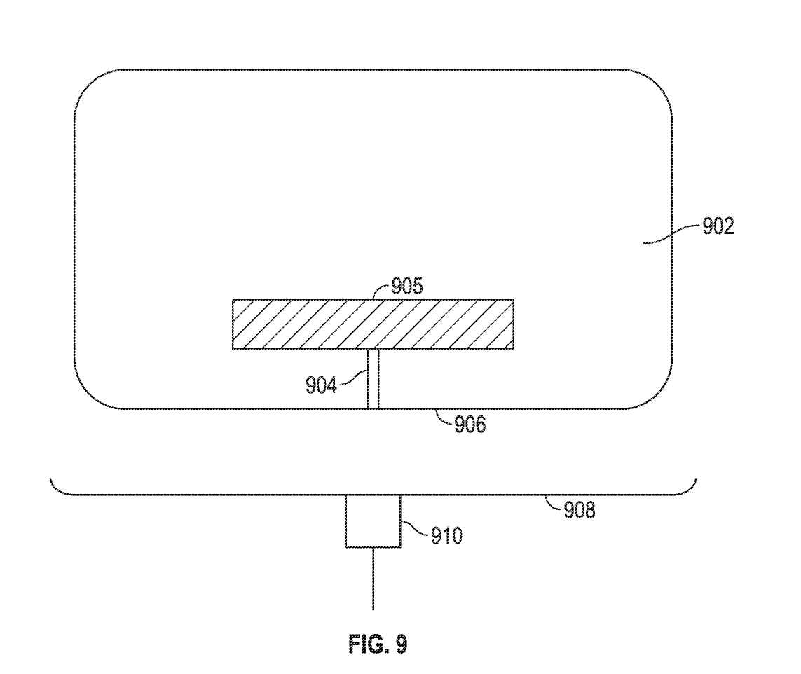

Activation and deactivation of lighting component 104 is accomplished via a suitable controller 105 (e.g., a lighting control module provided within the vehicle) that communicates with lighting component 104 via one or more electrically conductive traces, wires, or any other suitable conductors 106. In one embodiment, conductor 106 is implemented as a metallic conductor of the type often used in conjunction with auto glass with integral defrosting wires. In one embodiment, conductive trace 106 extends to an interconnect provided at an edge of the glass panel 102. Referring briefly to FIG. 9, for example, a glass panel 902 (shown here before installation) may include a lighting component 905 and a conductor 904 extending to edge 906 such that conductor 904 can be electrically coupled to interconnect 910 at inner edge 908 of the vehicle body opening that receives glass panel 902.

Referring again to FIG. 1, glass panel 102 may correspond to any auto glass component traditionally installed on a car body, including, for example, a front windshield, a rear window, a side door window, a moon roof, a side mirror, and/or the like. In that regard, FIGS. 3-8 depict a number of non-limiting examples of automotive vehicles having lighting assemblies integrated into their front and/or rear windows.

FIG. 3 is a front view of a vehicle 300 in accordance with one embodiment in which glass panel 302 is a front windshield (installed on vehicle body 301) the substantially planar lighting components 304 and 306 are configured as left and right turn signals. While lighting components 304 and 306 are illustrated as having a particular arrow shape, the invention is not so limited: any suitable left and right turn signal shapes may be employed for lighting components 304 and 306. In other embodiments, lighting components 304 and 306 may be configured, not as turn signals, but as fog lamps (e.g., with a rectangular or circular shape).

FIG. 4 is a rear view of a vehicle 400 in accordance with one embodiment in which glass panel 402 is a rear window, and the substantially planar lighting component 404 is configured as a warning light (e.g., as might be used in connection with traditional “flashers”). While lighting component 404 is illustrated as concentric triangles, the invention is not so limited.

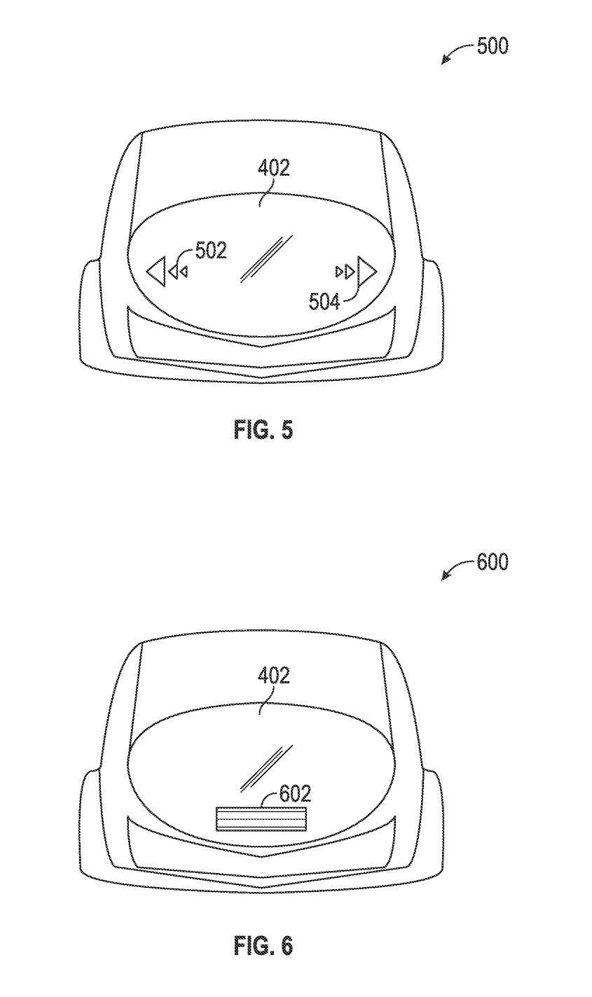

FIG. 5 is a rear view of a vehicle 500 in accordance with one embodiment in which glass panel 402 is a rear window and the substantially planar lighting components 502 and 504 are configured as left and right turn signals. While lighting components 502 and 504 are illustrated as a series of triangles of increasing size, the invention is not so limited. In some embodiments, simultaneous flashing of lighting components 502 and 504 may be used as a “warning” flasher, similar to that depicted in FIG. 4.

FIG. 6 is a rear view of a vehicle 600 in accordance with one embodiment in which glass panel 402 is again a rear window and substantially planar lighting component 602 is configured as a brake indicator. The size, position, and shape of lighting component 602 may vary depending upon, for example, the size and shape of vehicle 600. In some embodiments, lighting component 602 is uniformly illuminated during braking; in other embodiments, lighting component 602 is animated (e.g., bands of light propagating horizontally from the center outward or the like.)

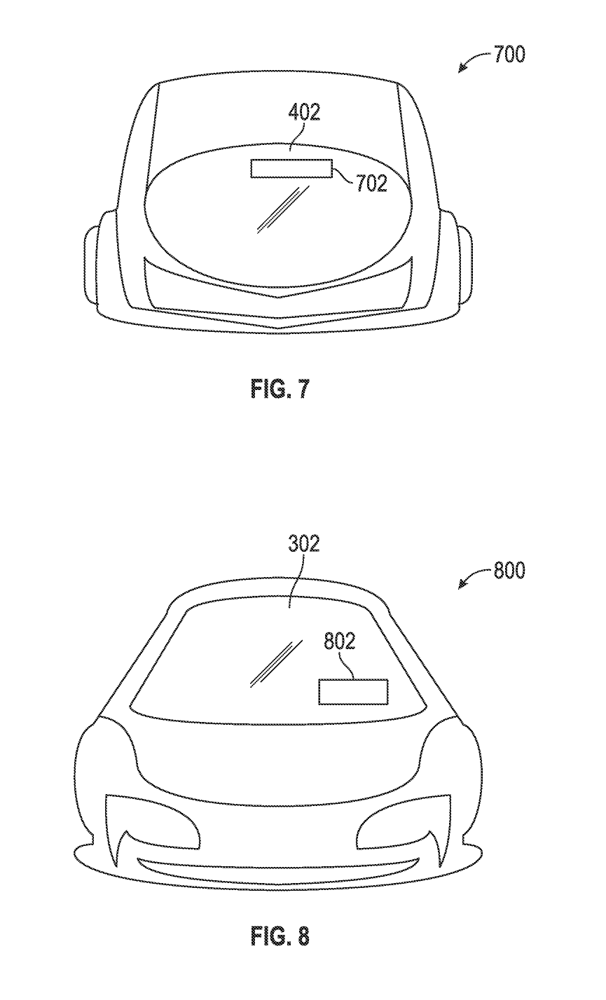

FIG. 7 is a rear view of a vehicle 700 in accordance with one embodiment in which glass panel 402 is a rear window and substantially planar lighting component 702 is configured to display a selected alphanumeric message as shown. The alphanumeric message (e.g., “Baby on Board,” “Apex Rental Cars,” “Go, Purdue!”, or the like) may be set by the manufacture or dealer of vehicle 700 or may be user-configurable. That is, the user of vehicle 700 may, using a suitable user interface (such as a central console touch screen), enter an arbitrary message or graphic to be displayed via lighting component 702.

FIG. 8 is a front view of a vehicle 700 in accordance with one embodiment in which glass panel 302 is a rear window and substantially planar lighting component 802 is within the field of view of the driver and is configured to display, in a way that is visible to the driver, selected information regarding the state of vehicle 800 or other information. That is, lighting component 802 may effectively function as a head-up display as is known in the art.

Referring to FIG. 11, a method 1100 of fabricating a lighting assembly will now be described in conjunction with the cross-sectional image shown in FIG. 2. The method begins at 1102 with forming or otherwise providing a glass panel 102 configured to be installed on a vehicle. As mentioned above, glass panel 102 may be a front windshield, a rear window, or any other glass component used in connection with vehicles. In one embodiment, as shown in FIG. 10, the glass panel may have a perimeter margin region 1007.

Next, at 1104, a substantially planar lighting component 104 is integrated into glass panel 102 in the perimeter margin region. As described above, this integration may be accomplished in a variety of ways, including adhesives, embedding of lighting component 104 within glass panel 102, or any other suitable integration method.

The method continues at 1106 by forming an electrically conductive trace 106 coupled to substantially planar lighting component 104 and extending to an edge of the glass panel (see FIG. 9). Finally, in accordance with one embodiment, a serigraphic layer (1006 in FIG. 10) is applied to the perimeter margin region of the glass panel such that the substantially planar light component is secured between the serigraphic layer and a surface 103 of glass panel 102.

In summary, what has been described is an improved automotive lighting assembly in which substantially planar lighting components are integrated into the windshield, rear window, and/or other auto glass panels. As a result, assembly (and repair) of the lighting system is simplified, cabling requirements are minimized, weight and manufacturing costs are reduced, and the vehicle's body styling can be designed without having to accommodate complicated light fixture shapes.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A lighting assembly for a vehicle, comprising:
a glass panel configured to be installed on the vehicle, the glass panel having a perimeter margin region; and
a substantially planar lighting component integrated into the glass panel in the margin region.

2. The lighting assembly of claim 1, wherein the perimeter margin region includes a serigraphic layer, and the substantially planar light component is disposed between the serigraphic layer and a surface of the glass panel.

3. The lighting assembly of claim 1, further including an electrically conductive trace coupled to the substantially planar lighting component and extending to an interconnect secured to an edge of the glass panel.

4. The lighting assembly of claim 1, wherein the substantially planar lighting component comprises a plurality of light-emitting diodes.

5. The lighting assembly of claim 1, wherein the glass panel is configured to be installed as a front windshield of the vehicle, and the substantially planar lighting component is configured as a turn signal.

6. The lighting assembly of claim 1, wherein the glass panel is configured to be installed as a rear window, and the substantially planar lighting component is configured as a brake indicator.

7. The lighting assembly of claim 1, wherein the glass panel is configured to be installed as a rear window, and the substantially planar lighting component is configured as a warning indicator.

8. The lighting assembly of claim 1, wherein the glass panel is configured to be installed as a front windshield of the vehicle, and the substantially planar lighting component is configured as a fog lamp.

9. The lighting assembly of claim 1, wherein the glass panel is configured to be installed as a rear window, and the substantially planar lighting component is configured to display a selected alphanumeric message.

10. A vehicle comprising:
a vehicle body;
a plurality of glass panels installed on the vehicle; and
a first substantially planar lighting component integrated into a perimeter margin region of a first glass panel of the plurality of glass panels.

11. The vehicle of claim 10, wherein the perimeter margin region of the first glass panel includes a serigraphic layer, and the first substantially planar light component is disposed between the serigraphic layer and a surface of the first glass panel.

12. The vehicle of claim 10, further including an electrically conductive trace coupled to the first substantially planar lighting component and extending to an interconnect secured to an edge of the first glass panel.

13. The vehicle of claim 10, wherein the first glass panel is a front windshield of the vehicle, and the first substantially planar lighting component includes a first pair of turn signals.

14. The vehicle of claim 13, further including a second glass panel having a second substantially planar lighting component integrated therein, wherein the second glass panel is a rear window of the vehicle, and the second substantially planar lighting component is a brake indicator.

15. The vehicle of claim 14, wherein the second glass panel has a third substantially planar lighting component integrated therein, and the third substantially planar lighting component includes a second pair of turn signals.

16. A method of fabricating a lighting assembly of a vehicle, the method comprising:
providing a glass panel configured to be installed on the vehicle, the glass panel having a perimeter margin region; and
integrating a substantially planar lighting component into the glass panel in the perimeter margin region; and
forming an electrically conductive trace coupled to the substantially planar lighting component and extending to an edge of the glass panel.

17. The method of claim 16, further including applying a serigraphic layer to the perimeter margin region of the glass panel such that the substantially planar light component is secured between the serigraphic layer and a surface of the first glass panel.

18. The method of claim 16, wherein the glass panel is a front windshield of the vehicle, and the first substantially planar lighting component includes a first pair of turn signals.

19. The method of claim 16, wherein the glass panel is a rear window of the vehicle, and the substantially planar lighting component is configured as a braking indicator.

20. The method of claim 16, wherein the substantially planar light component comprises a plurality of light-emitting diodes.
